(19) United States
(12) Patent Application Publication
(10) Pub. No.: US 2026/0357941 A1
(43) Pub. Date: Nov. 12, 2026

(54) DIRECT BURIAL ENCLOSURE FOR PLUMBING FITTINGS AND METHODS

(71) Applicant: RELIANCE WORLDWIDE CORPORATION, Atlanta, GA (US)

(72) Inventor: Joseph Derres CATALANO, Roswell, GA (US)

(21) Appl. No.: 19/102,023

(22) PCT Filed: Aug. 10, 2023
(86) PCT No.: PCT/US2023/029964

§ 371 Date: Feb. 7, 2025

Related U.S. Application Data
(60) Provisional application No. 63/370,984, filed on Aug. 10, 2022.

(51) Int. Cl. F16L 58/18; F16L 1/028; F16L 41/02

(52) U.S. Cl. CPC F16L 58/188; F16L 41/021; F16L 1/028

(57) ABSTRACT

A protective case includes an enclosure including a shaped cavity, the enclosure including a first and second enclosure portions coupled together via a hinge, a sealing gasket shaped to conform to at least a portion of the enclosure, and a joining mechanism to secure the first and second enclosure portions together in a closed configuration with the sealing gasket therebetween. A method of making a protector case for a pipe fitting for direct burial application includes providing a first and second enclosure portions, each enclosure portion including side features and having a concave configuration, coupling the enclosure portions at a hinge, inserting a sealing gasket inside the enclosure portions, and providing a closing mechanism. In a closed configuration, the side features of the first and second enclosure portions form a plurality of openings, and the concave configurations join to form a concave space to receive the plumbing fitting.

### PRIORITY CLAIM

This Application claims priority to U.S. Patent Application No. 63/370,984, filed Aug. 10, 2022.

### INCORPORATION BY REFERENCE

The disclosure and figures of U.S. Patent Application No. 63/370,984, filed Aug. 10, 2022, are incorporated by reference herein as if set for in their entireties.

### FIELD

The present disclosure relates generally to pipe fittings. More specifically, the present disclosure relates to a device and method for assembling plumbing fittings, couplings, or connectors, that are designed to be buried underground.

### BACKGROUND

Conduits and pipes are used to carry a variety of media such as, e.g., liquids and/or gases, sometimes underground. Couplings, connectors, and fittings are used to join the conduits and pipes in various ways so that the conduits and pipes can be arranged in different configurations to move the media through the conduits and pipes. The conduits and pipes may be rigid as with metal or plastic pipes used in household plumbing applications, or the conduits and pipes may be flexible. Connectors are used for end-to-end connection of conduits and pipes, or they can route conduits and pipes at different directions relative to the conduit axis. For example, connectors can be employed to change the direction of piping, such as, e.g., by an angle of 45° or 90° with respect to a flow passage through the pipe to which the connector is connected. Connectors can also be employed to branch or split piping in different directions. For example, a single pipe section can be connected by a T-fitting, a Y-fitting, a multi-conduit joint, or a change in diameter.

Typical methods of protecting a fitting, e.g., a push-to-connect (PTC) fitting, from environmental and other degradations when buried underground include using a silicone wrapping. Such silicone tape wrapping methods designed to protect the fitting are typically time consuming and tedious to use.

### SUMMARY

In one aspect, the technology relates to a protective case for a pipe fitting, the protective case including an enclosure including a shaped cavity, the enclosure including a first enclosure portion and a second enclosure portion, the first enclosure portion and the second enclosure portion being coupled together via a hinge, a scaling gasket shaped to conform to at least a portion of the enclosure, and a joining mechanism configured to secure the first and second enclosure portions together in a closed configuration with at least a portion of the sealing gasket positioned therebetween. In various examples, when in the closed configuration, the enclosure defines a plurality of openings arranged in at least a three-prong configuration to receive at least two pipes that are oriented to conform to a configuration of the pipe fitting.

In an example of the above aspect, the sealing gasket includes a first sealing gasket that mounts within a cavity of the first enclosure portion and a second sealing gasket that mounts within a cavity of the second enclosure portion. When the enclosure is in the closed configuration, the first and second sealing gaskets together define a plurality of gasket openings. In other examples, the first and second sealing gaskets each include a pipe portion, and when the first and second enclosure portions are in the closed configuration, the first and second sealing gaskets together form a plug at one or more of the plurality of gasket openings. In other examples, each gasket opening coincides with a respective one of the openings. In another example, the protective case also includes a removable plug configured to seal one of the openings. For example, the removable plug has a threaded configuration.

In another example of the above aspect, the sealing gasket extends along a portion of at least a perimeter of one of the first enclosure portion and the second enclosure portion. In other examples, the sealing gasket includes a sheet extending between the first enclosure portion and the second enclosure portion, the sheet being, e.g., a silicone sheet. In another example, the joining mechanism includes at least one of a clasp, a wire tie, and a screw. In yet another example, a length of the protective case along a first axis is equal to or smaller than 4.8 in, and may be between 4.4 in and 4.8 in. As another example, a width of the protective case along a second axis is equal to or smaller than 3.6 in, and may be between 3.0 in and 3.6 in. In a further example, a radius of an opening of the protective case is equal to or smaller than 1.8 in, and may be between 1.4 in and 1.8 in. In another example of the above aspect, the shape of the pipe fitting may have a straight line shape, an elbow shape, a T-shape, a Y-shape, and a star shape. In an example, the hinge of the enclosure is a living hinge.

In another aspect, the technology relates to a method of making a protector case for a pipe fitting for direct burial application. The method includes providing an enclosure having a first shell portion and a second shell portion for housing the pipe fitting, inserting a sealing gasket within the enclosure portion, and providing a closing mechanism for securing the first enclosure portion to the second enclosure portion. For example, in a closed configuration, the first shell portion and the second shell portion join together to form a plurality of openings in at least a three-prong configuration for receiving at least two pipes that are oriented to conform to a configuration of the pipe fitting. In an example of the above aspect, inserting the sealing gasket within the enclosure includes inserting a silicone sheet between the first shell portion and the second shell portion.

In yet another aspect, the technology relates to a method of protecting a pipe fitting. The method includes providing a housing including a first clamshell and a second clamshell, the first and second clamshells being configured to couple together in a closed configuration to define an interior and a plurality of pipe openings that form at least a 3-prong configuration, inserting a seal member into the housing to form a seal when the first and second clamshells are in the closed configuration, the seal member having a removable seal part that forms a plug at each one of the pipe openings, placing the pipe fitting into the interior of the housing, removing the plug of the removable seal part to provide access into the interior of the housing through a respective one of the plurality of pipe openings, inserting, where the plugs have been removed, a pipe member, and connecting the pipe member with the pipe fitting within the housing, and securing the first and second clamshells in the closed configuration such that the removable seal part of the seal member forms a seal about the pipe member at the plurality of pipe openings. In an example, the seal member has a length that extends around the pipe member between about ¼ inch to about 1 inch.

Various exemplary descriptions below contain instances of representative ranges, dimensions and/or tolerances for certain components. These are provided by way of illustration and not by way of limitation. Unless otherwise indicated, all numbers expressing quantities of properties, parameters, conditions, and so forth, used in the specification and claims are to be understood as being modified in all instances by the terms “about” or “approximately.” Accordingly, unless indicated to the contrary, the numerical parameters set forth in the following specification and attached claims are approximations. Any numerical parameter should at least be construed in light of the number reported significant digits and by applying ordinary rounding techniques. The terms “about” or “approximately” when used before a numerical designation, e.g., a dimension of a measured property, indicates approximations which may vary by (+) or (−) 10%, 5% or 1%.

### BRIEF DESCRIPTION OF THE FIGURES

The accompanying drawings, which are incorporated in and constitute a part of the description, illustrate several principles of the present disclosure. A brief description of the drawings is as follows:

FIGS. 1A-1I are illustrations of a protective case for a pipe fitting, according to various examples of the disclosure.

FIGS. 2A-2F are illustrations of a protective case for a pipe fitting, according to various examples of the disclosure.

FIGS. 3A-3F are illustrations of a protective case for a pipe fitting, according to various examples of the disclosure.

FIGS. 4A-4I are illustrations of a protective case for a pipe fitting, according to various examples of the disclosure.

FIGS. 5A-5B are illustrations of a protective case for a pipe fitting, according to various examples of the disclosure.

FIG. 6 is an illustration of a protective case for a pipe fitting, according to various examples of the disclosure.

FIG. 7 is an illustration of a protective case for a pipe fitting, according to various examples of the disclosure.

FIG. 8 is a flow chart illustrating a method of making a protector case for a pipe fitting for direct burial application, according to various examples of the disclosure.

FIG. 9 is a flow chart illustrating a method of protecting a pipe fitting, according to various examples of the disclosure.

FIG. 10A-10H are illustrations of another protective case for a pipe fitting, according to various examples of the disclosure.

FIGS. 11A-11F are illustrations of a gasket that can be used with any of the protective cases and pipe fittings disclosed herein, according to various examples of the disclosure.

FIGS. 12A-12E are illustrations of the protective case from FIGS. 10A-10H assembled with a first pipe fitting, according to various examples of the disclosure.

FIGS. 13A-13E are illustrations of the protective case from FIGS. 10A-10H assembled with a second pipe fitting, according to various examples of the disclosure.

FIGS. 14A-14E are illustrations of the protective case from FIGS. 10A-10H assembled with a third pipe fitting, according to various examples of the disclosure.

FIGS. 15A-15E are illustrations of the protective case from FIGS. 10A-10H assembled with a fourth pipe fitting, according to various examples of the disclosure.

### DETAILED DESCRIPTION

As used herein, the relative directions and terms “inward” and “outward” are referenced with respect to a longitudinal axis, with inward being in a direction radially toward the longitudinal axis and outward being in a direction radially away from the longitudinal axis.

The relative directions and terms “distal” and “proximal” are used with respect to a connector assembly fastened to an end of a fluid conduit, with the distal direction being toward the end of the connector assembly on the end of the fluid conduit (e.g., the receiving end of the connector assembly), and the proximal direction being toward the beginning of the fluid conduit to which the connector assembly is fastened. The relative direction and term lateral or laterally are in a plane generally orthogonal to the longitudinal axis.

Various examples of the disclosure include a burial enclosure that is a sealed case for direct burial of, e.g., a plumbing fitting. The sealed case provides a substantially airtight and watertight sealed environment to protect the fitting from environmental and other degradation. Other examples include a direct burial assembly for facilitating direct burial of, e.g., a PTC fitting. A PTC fitting may include a connector body, a sealing member or sealing gasket, a grab ring, a cartridge, a retainer sleeve, a plurality of latches, and an interference portion. The connector body has a fluid passage that extends at least partially therethrough. The sealing gasket is configured to form a sealing engagement with a fluid conduit. The grab ring includes a plurality of teeth configured for coupling to the fluid conduit. The cartridge is positioned adjacent to at least part of the grab ring and has a hollow portion therethrough. The grab ring is interposed between the cartridge and the sealing gasket when the push-to-connect fitting is assembled. The retainer sleeve is received over at least part of the cartridge and is received over at least part of the connector body. The plurality of latches are located on the retainer sleeve and are configured to secure the retainer sleeve to the connector body to facilitate retention of the sealing gasket, the grab ring, and the cartridge. The interference portion is interposed between the connector body and the retainer sleeve when the push-to-connect fitting is assembled. The interference portion is configured to engage the retainer sleeve to substantially prevent rotation of the retainer sleeve relative to the connector body.

In various examples of the disclosure, the assembly may include a case or housing at least partially defining a chamber or cavity that is shaped, sized, dimensioned, or otherwise configured to receive and house a plumbing fitting, such as, e.g., a PTC fitting, a push-fit fitting, or other plumbing fittings, couplings, or connectors. The case or housing may also include a plurality of fluid passageway openings, each fluid passageway opening being configured to receive a tubing or conduit for connecting to the fitting. In other examples, the assembly may include one or more sealing gaskets configured to provide a seal between the case and the tubing or conduit received therein. The seal may substantially prevent, reduce, or inhibit, the introduction of contaminants into the chamber. In other examples, the one or more sealing gaskets may further include a plurality of knock-out, or removable, portions that allow for selective use of the plurality of openings, such that the direct burial assembly may accommodate fittings having different configurations, such as, e.g., straight-line configurations, elbow configurations, T-shaped configurations, star-shaped configurations, y-shaped configurations, and the like.

In various examples, the seal and the case may be manufactured as a single item through, e.g., co-molding or two-shot molding. For example, the case may be a one-piece folding case using a living hinge connecting two enclosure portions, the single seal design may be used in each enclosure portion, and the mating may be achieved by using a face seal when the enclosure portions are closed and joined together. Other examples may include a two-seal design that uses mating of interlocking features to create a seal when the case halves are closed and joined together. Advantages of the examples of the disclosure include the fact that the case is re-openable, the installation of the case may be a tool-less installation, the installation of the case is low cost, and the case is aesthetically pleasing.

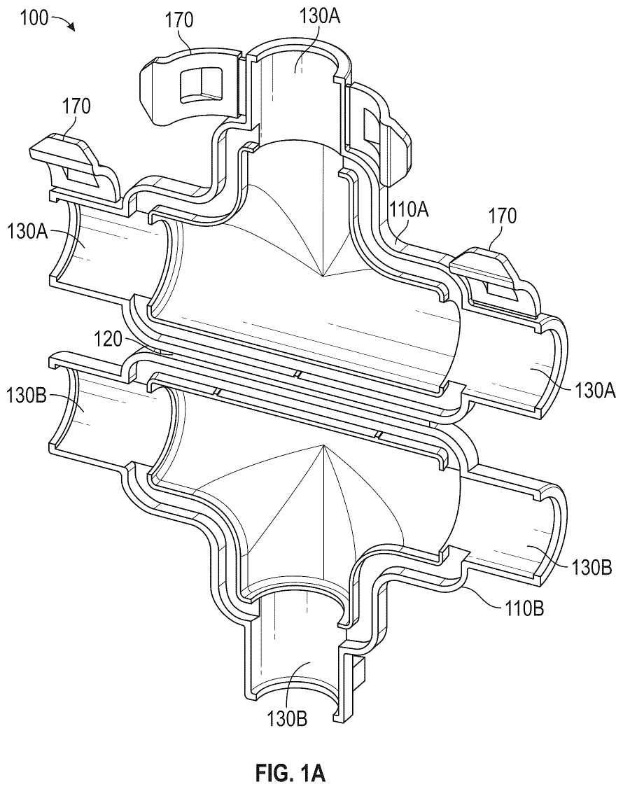

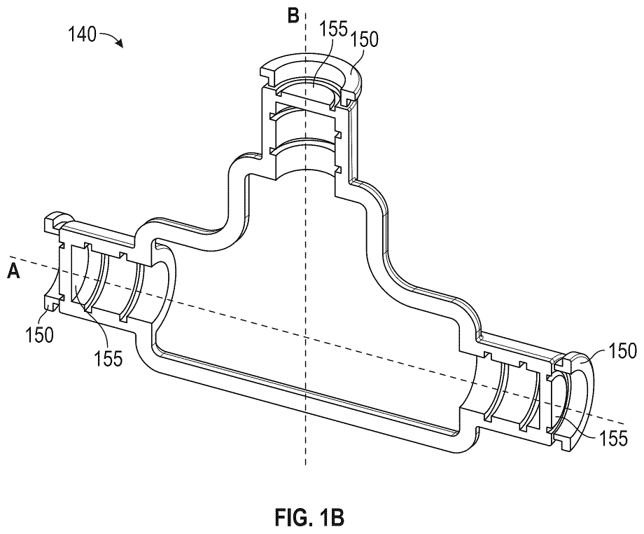

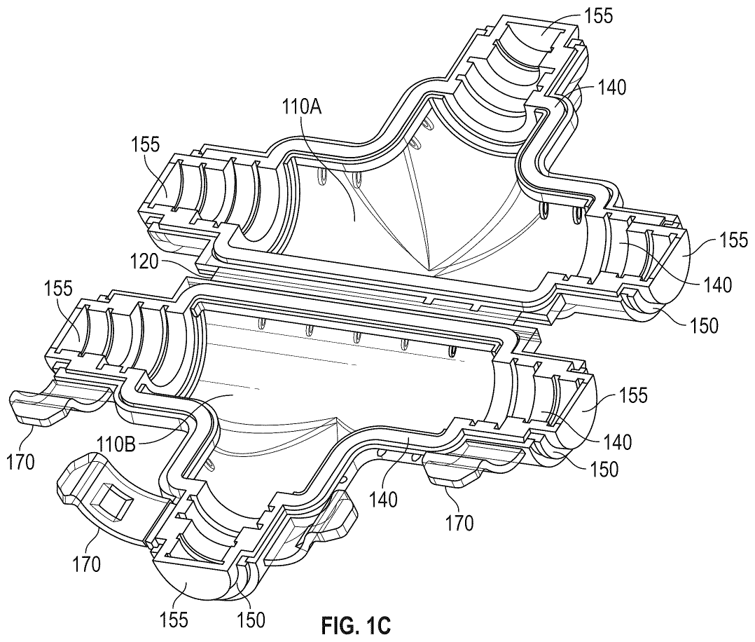

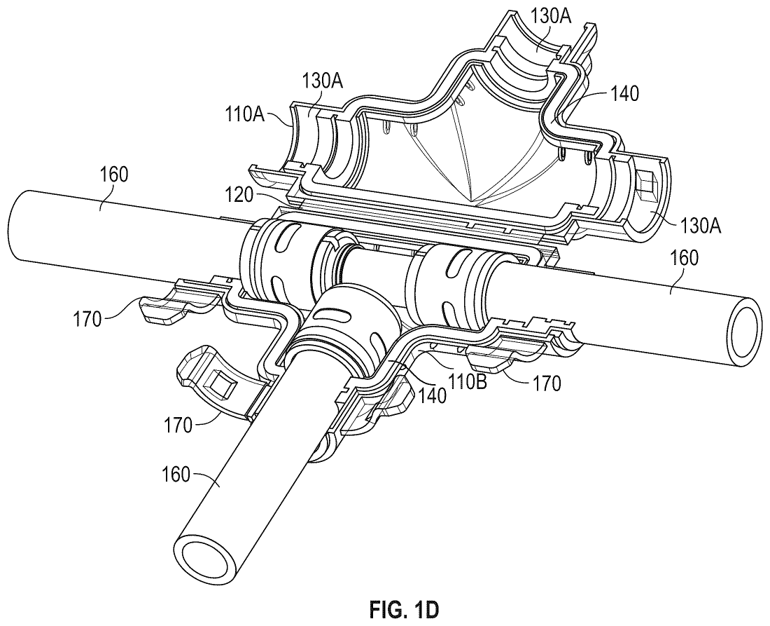

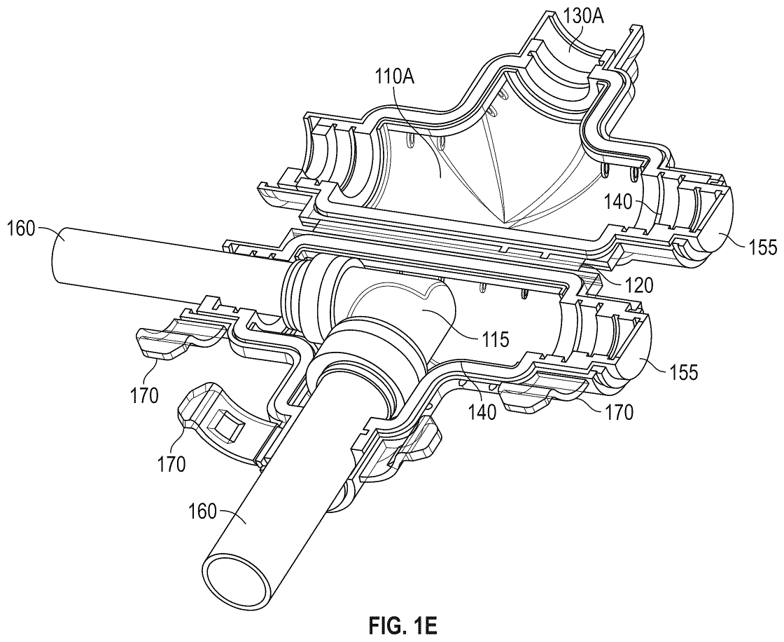

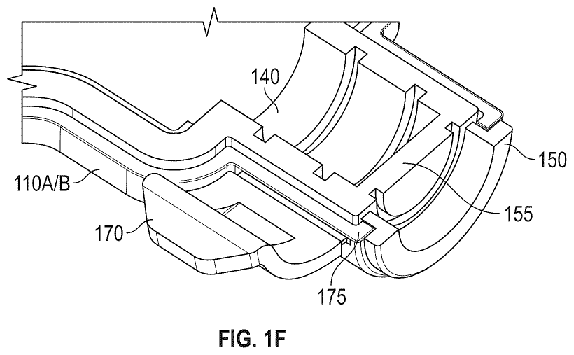

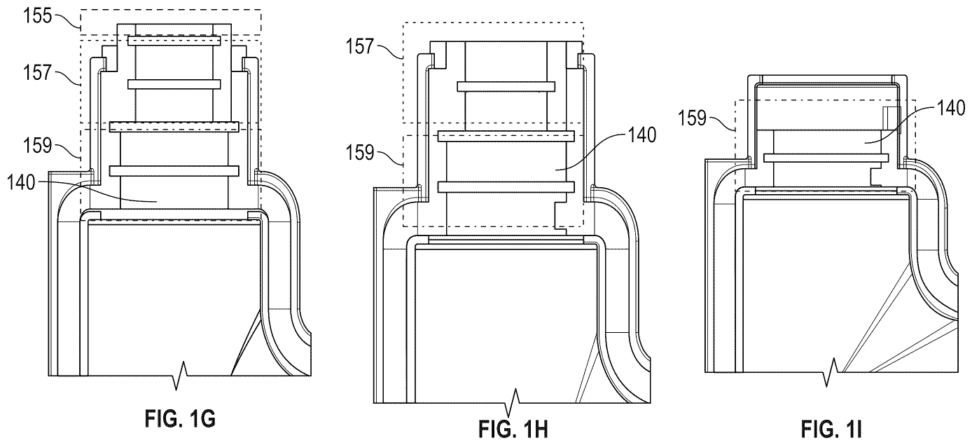

FIGS. 1A-1I are illustrations of a protective case, according to various examples of the disclosure. FIG. 1A illustrates a protective case 100, according to various examples of the disclosure. In FIG. 1A, the protective case 100 includes two enclosure portions, or half-cases, 110A and 110B connected together via a hinge 120 such as, e.g., a living hinge 120, although alternatives are possible. Each of the enclosure portions 110A and 110B includes a plurality of openings 130A and 130B, each opening forming part of a fluid passageway when the enclosure portions 110A and 110B are closed together upon folding of the protective case 100 at the hinge 120. In various examples, each of the enclosure portions 110A and 110B includes a shaped cavity, and when joined together form a fluid passageway in which, e.g., a sealing gasket (not shown) or a pipe fitting (not shown) may be inserted or disposed. In various examples, a volume inside the enclosure formed when the enclosure portions 110A and 110B are closed may be about 2.3 cubic inch.

FIG. 1B illustrates a sealing gasket 140, according to various examples of the disclosure. In FIG. 1B, the sealing gasket 140 includes three sealing plugs 150, and defines fluid passageways along two axis “A” and “B.”. In operation, the sealing gasket 140 may be made of a single mold design, and may be inserted between the two enclosure portions 110A, 110B of the protective case 100 discussed above with respect to FIG. 1A and a fitting, e.g., a plumbing fitting or plumbing connection. The plumbing fitting may have a straight shape, an elbow shape, a T-shape, a Y-shape, or a star shape, as further discussed below. In various examples, the sealing plugs 150 may be removable and may be removed to accommodate a conduit or pipe therethrough. In various examples, a volume inside the sealing gasket 140 may be about 0.64 cubic inch.

FIG. 1C illustrates the sealing gasket 140 illustrated in FIG. 1B inserted in the protective case 100, according to various examples of the disclosure. In FIG. 1C, two sealing gaskets 140 are inserted in the enclosure portions 110A and 110B of the protective case 100, respectively. FIG. 1D illustrates a protective case in operation, according to various examples of the disclosure. In FIG. 1D, the protective case 100 is in an open configuration, and one of the first enclosure portion 110A and the second enclosure portion 110B encloses one or more pipe fitting tubes 160 in a fluid configuration. In various examples, although FIG. 1D illustrates pipe fitting tubes 160 in a T-shaped configuration, the pipe fitting tubes 160 may be arranged in a straight configuration, an elbow configuration, a T-shaped configuration, a Y-shaped configuration, or a star shaped configuration to conform to the type of fitting housed within the protective case 100. In the example illustrated in FIG. 1D, the closing or joining mechanisms 170 are clasps 170, but may be or include other types of closing or fastening mechanisms such as, e.g., a wire tie, and a screw. FIG. 1E illustrates another protective case in operation, according to various examples of the disclosure. In FIG. 1E, instead of a T-shaped configuration, the pipe fitting tubes 160 are in an elbow configuration and are joined together by an elbow-shaped connector 115 configured to form a fluid pathway between both pipe fitting tubes 160.

During use, the protective case 100 can be in a closed configuration where both the first enclosure portion 110A and the second enclosure portion 110B are connected together via the hinge 120 on one side thereof, and also via one or more closing or joining mechanisms 170 at cach extremity thercof, although alternatives arc possible. The closing or joining mechanisms 170 are clasps 170, but may be or include other types of closing or fastening mechanisms such as, e.g., a wire tie, and a screw. For example, the enclosure portions 110A/110B and the sealing gasket 140, in a closed configuration, form a fluid passageway that can receive a pipe fitting tube 160. Due to the configuration of the enclosure portions 110A/110B and the sealing gasket 140 when the clasps 170 are closed, the pipe fitting connection (not shown) inside the sealing gasket 140 and the enclosure portions 110A/110B is sealed, e.g., hermetically sealed, and protected from the environment. In various examples, although FIG. 1D illustrates pipe fitting tubes 160 in a T-shaped configuration, the pipe fitting tubes 160 may be arranged in a straight configuration, an elbow configuration, a T-shaped configuration, a Y-shaped configuration, or a star shaped configuration to conform to the type of fitting housed within the protective case 100. For example, the enclosure portions 110A and 110B form enclosure having a shaped cavity, and defines a plurality of openings arranged in at least a three prong configuration to receive at least two pipes that are oriented to conform to a configuration of the pipe fitting (not shown).

FIG. 1F illustrates a sealing plug 150, according to various examples, the sealing plug 150 may include a plug portion 155 that is integrally formed within the fluid passageway formed by the sealing plug 150. In examples, when the sealing gasket 140 is to be used to protect a plumbing fitting or plumbing connection therein, the plug portion 155 is removable and may be removed so as to allow for the insertion of a pipe fitting tube 160 (see above in FIG. 1D), and the sealing plug 150 which can include a pipe fitting tube 160 (not shown) may then be closed via, e.g., a clasp 170. In certain examples, the plug portion 155 may be removed by cutting the plug portion 155 from the sealing plug 150. In other examples, the plug portion 155 may be removed by stamping out the plug portion 155 from the sealing plug 150.

FIGS. 1G-1I are illustrations of sealing plugs 150, according to various examples of the disclosure. In FIG. 1G, a closed or seal end portion 155 sits at an end of the sealing gasket 140 on top of one or more sections 157 and 159. For example, section 157 may have a width of a half (½) inch, and section 159 may have a width of three-quarters (¾) of an inch. Accordingly, the same gasket 140 may be used for pipe fittings (not shown) of various diameters. For example, fittings that are ¾ inch in diameter may be fitted within the gasket 140 by removing the plug portion 155 and the section 157 as shown in FIG. 1I, so that the pipe fitting may be inserted in section 159. Similarly, fittings that are ½ inch in diameter may be fitted within the gasket 140 by only removing the plug portion 155 as shown in FIG. 1H, so that the pipe fitting may be inserted in section 157. In various examples, this “step down” configuration may allow for the gasket to fit pipe fittings of various sizes. Although sizes of ½ inch and ¾ inch are illustrated in FIG. 1G and FIG. 1H, the sections 157 and 159 may have various sizes different than ½ inch or ¾ inch. In addition, although two sections 157 and 159 are illustrated herein, the gasket 140 may include more than two sections having varying diameters so as to accommodate a greater variety of pipe fitting sizes.

In FIG. 1H, the gasket 140 does not have a plug portion 155 and is open and able to receive, e.g., a pipe fitting. By having sections 157 and 159 of various widths, the gasket 140 may accommodate pipe fittings of various corresponding widths. Turning again to FIG. 1F, an illustration of a clasping mechanism designed to hold together the sealing gasket 140 and the enclosure portions 110A/110B is depicted according to various examples of the disclosure. In examples, the sealing gasket 140 and the enclosure portions 110A/110B may be secured together via a flange connection 175.

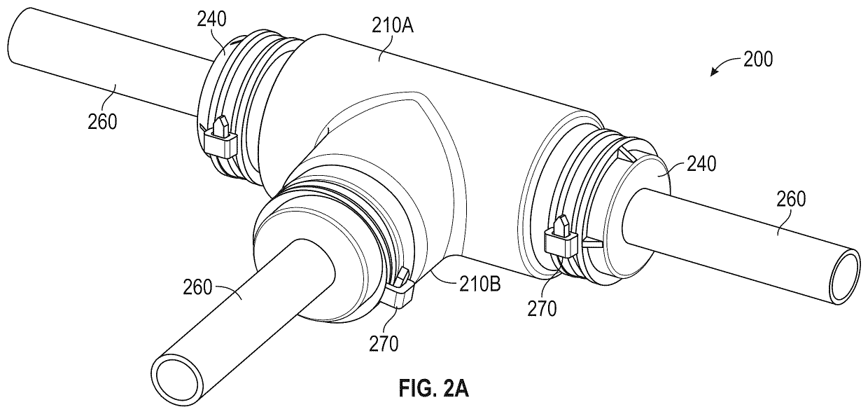

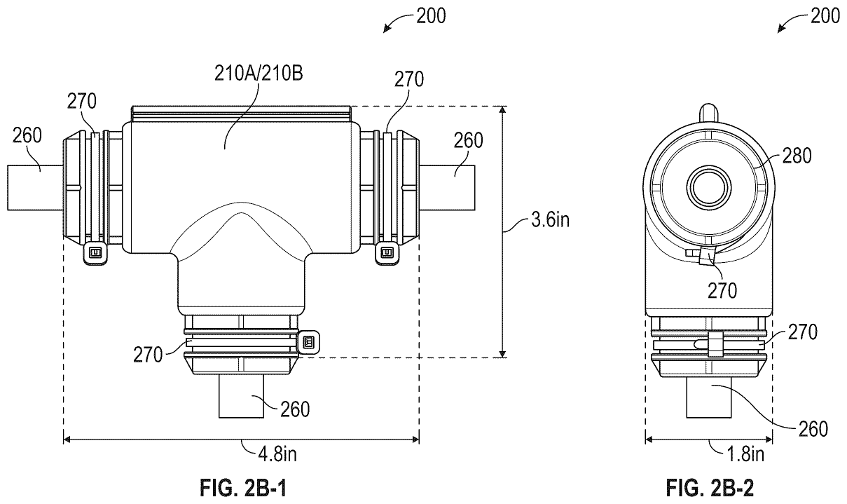

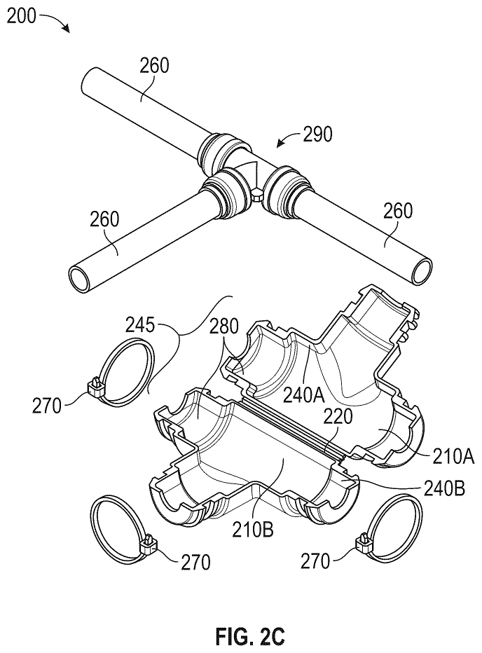

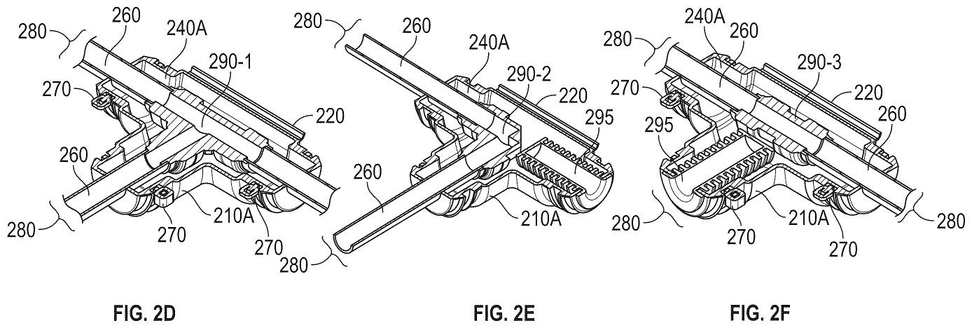

FIGS. 2A-2F are illustrations of a protective case for a pipe fitting, according to various examples of the disclosure. FIG. 2A is an illustration of a protective case 200 in operation, according to various examples of the disclosure. In FIG. 2A, both enclosure portions 210A and 210B are closed around a sealing gasket 240, and the combination of the enclosure portions 210A/210B and the sealing gasket 240 constitutes a protective case over a pipe fitting (not shown) for connecting pipe tubes 260. For example, the gasket 240 may be sandwiched between the enclosure portions 210A and 210B, and specifically at least the perimeter of the gasket 240 is sandwiched between the perimeters of the enclosure portions 210A and 210B. In other examples, in a closed configuration as shown in FIG. 2A, the enclosure portions 210A and 210B are joined together via one or more wire or zip ties 270. In FIG. 2B-1 and FIG. 2B-2, dimensions of protective case 200 for a pipe fitting, according to various examples of the disclosure, are illustrated. The protective case 200 illustrated in FIG. 2B-1 and FIG. 2B-2 is similar to the protective case 200 illustrated in FIG. 2A. The radius of at least one opening 280 of the protective case 200 through which a pipe fitting tube 260 may be inserted is equal to about 1.8 in. In other examples, a width of the protective case 200 along one axis is equal to about 3.6 in, and a length of the protective case 200 along another axis is equal to about 4.8 in.

In various examples, FIG. 2C is an exploded view of the protective case 200 of FIG. 2A, in accordance with various examples of the disclosure. In FIG. 2C, the protective case 200 includes enclosure portions 210A and 210B connected together via a hinge 220 at a side thereof, a pipe fitting assembly 290 that is to be enclosed within the enclosure portions 210A and 210B, a sealing gasket 240 lining the enclosure portions 210A and 210B, and wire or zip ties 270 to securely and hermetically enclose the pipe fitting assembly 290 within the enclosure portions 210A and 210B with the sealing gasket 240 inserted therebetween, in accordance with various examples. In examples, the outer surfaces of the enclosure portions 210A and 210B may be made of, or may include, a silicon gel or a plastic such as, e.g., a hard plastic. For example, the enclosure portions 210A and 210B form an enclosure having a shaped cavity, and defines a plurality of openings 280 arranged in at least a three prong configuration to receive at least two pipes 260 that are oriented to conform to a configuration of the pipe fitting 290.

According to various examples of the disclosure, the pipe fitting 290 can be inserted within the enclosure portions 210A and 210B, where the sealing gasket 240 is between the enclosure portions 210A and 210B and the pipe fitting 290 so as to ensure a snug and/or hermetic fit when the enclosure portions 210A and 210B are joined together and closed. For example, an upper portion or first sealing gasket 240A may be in contact with the enclosure portion 210A, and a lower portion or second sealing gasket 240B may be in contact with the enclosure portion 210B, and the first sealing gasket 240A and the second sealing gasket 240B may be distinct portions. Alternatively, the upper portion or first sealing gasket 240A and the lower portion or second sealing gasket 240B may be integrally formed. In another example, the upper portion or first sealing gasket 240A is received within the cavity and along a perimeter of the enclosure portion 210A, and the lower portion or second sealing gasket 240B is received within the cavity and along a perimeter of the enclosure portion 210B, the upper portion or first sealing gasket 240A and the lower portion or second sealing gasket 240B forming a mating face seal when the enclose portions 201A and 201B are in a closed configuration. In examples, when the enclosure of the protective case 200 is in the closed configuration, the first and second sealing gaskets 240A/240B together define a plurality of gasket openings 245 (see FIG. 2C).

In an example, the enclosure portions 210A and 210B are joined together upon closing via wire ties 270 (see FIG. 2C).

In other examples, FIG. 2D, FIG. 2E, and FIG. 2F illustrate various types of pipe fittings 290 that may be protected by the protective case 200, according to various aspects. In various examples, FIG. 2D illustrates a T-shaped pipe fitting 290-1, FIG. 2E illustrates an elbow-shaped fitting 290-2, and FIG. 2F illustrates a straight-line shaped fitting 290-3. In each of the cases illustrated in FIGS. 2D, 2E and 2F, the enclosure portion 210A is the same, as discussed above with respect to FIGS. 2A-2C. However, in the case of the straight fitting 290-3, where only two of the openings 280 form a fluid passageway and can house a pipe fitting tube 260, in an opening 280 that does not receive a pipe fitting tube 260, a removable plug 295 is inserted. In various examples, the removable plug 295 is configured to seal one of the plurality of openings and ensures that the pipe fitting 290-3 remains sealed and protected from the environment. For example, the combination of the sealing gasket 240, the enclosure portions 210A/210B and the removable plug 295 provide a snug and/or hermetic sealing of the pipe fitting 290-3 enclosed therein. Similarly, in the case of an elbow-shaped fitting 290-2 illustrated in FIG. 2E, the removable plug 295 may be inserted in one of the openings 280 that does not house a pipe fitting tube 260, and also provides a snug and/or hermetic sealing of the pipe fitting 290-2 enclosed therein. FIG. 2D does not show any plug such as removable plug 295 because each opening 280 houses a pipe fitting tube 260.

In other examples, the first and second sealing gaskets 240A/240B each include a pipe portion, and wherein, when the first and second enclosure portions 210A/210B are in the closed configuration, the first and second sealing gaskets 240A/240B together form a plug (not shown but illustrated as 155 in FIG. IF) at one or more of the plurality of gasket openings 245. Also, each one of the plurality of gasket openings 245 may coincide with a respective one of the plurality of openings 280 of the case.

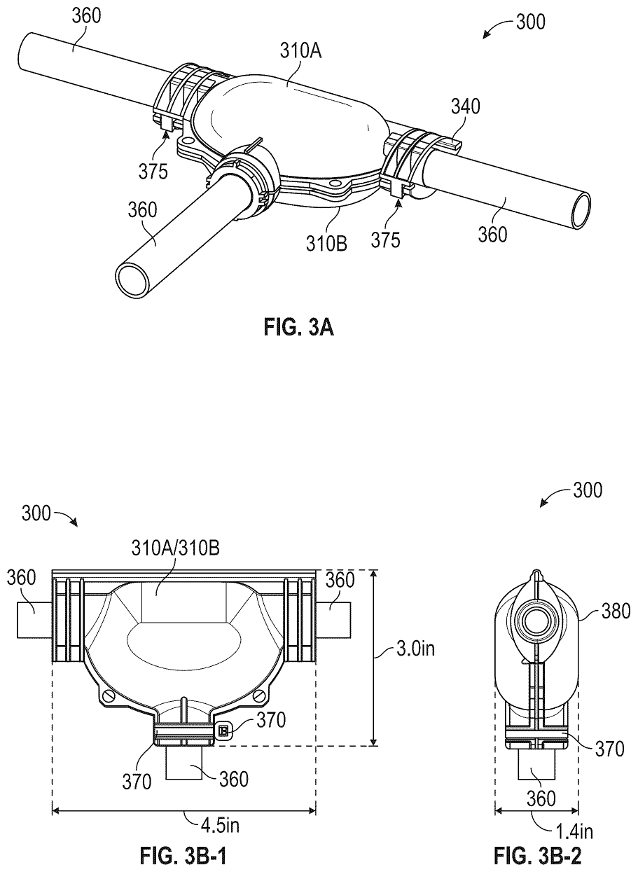

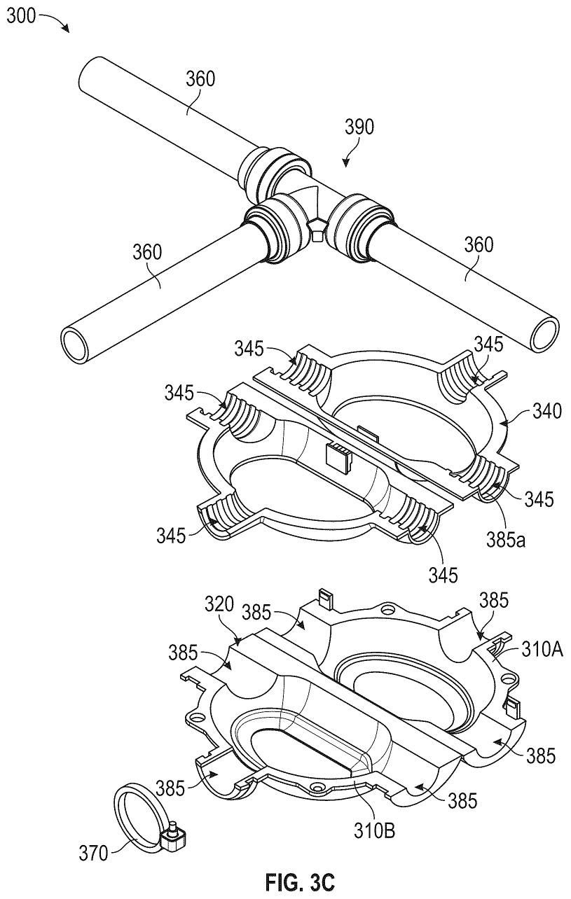

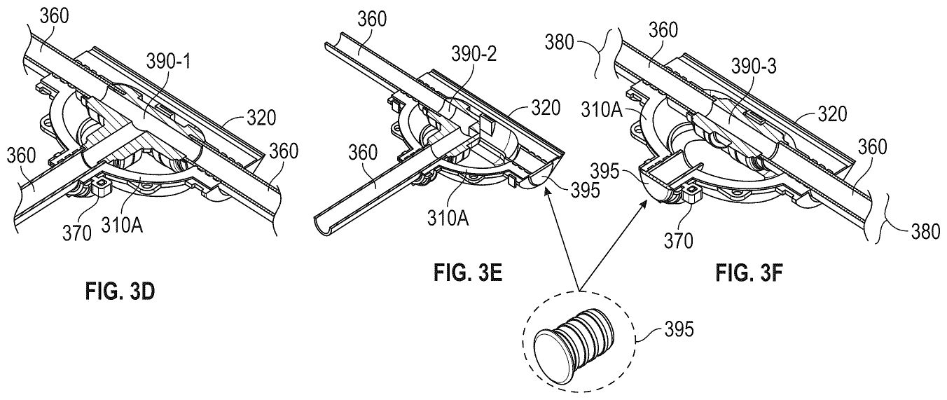

FIGS. 3A-3F are illustrations of a protective case for a pipe fitting, according to various examples of the disclosure. FIG. 3A is an illustration of a protective case 300 in operation, according to various examples of the disclosure. In FIG. 3A, both enclosure portions 310A and 310B are closed around a sealing gasket 340 which may be, e.g., a compression molded gasket. For example, the enclosure portions 310A and 310B have a flat and rigid outer surface. The combination of the enclosure portions 310A/310B and the sealing gasket 340 constitutes a protective case over a pipe fitting (not shown) for fitting pipe tubes 360 together. For example, the enclosure portions 310A and 310B are joined together via one or more wire ties 270. In FIG. 3B, dimensions of a protective case for a pipe fitting, according to various examples of the disclosure, are illustrated. The protective case 300 illustrated in FIG. 3B is similar to the protective case 300 illustrated in FIG. 3A, and the radius of an opening 380 of the protective case 300 through which a pipe fitting tube 360 may be inserted is equal to about 1.4 in. In other examples, a width of the protective case 300 along one axis is equal to about 3.0 in, and a length of the protective case 300 along another axis is equal to about 4.5 in.

In various examples, FIG. 3C is an exploded view of the protective case 300 illustrated in FIG. 3A. In FIG. 3C, the exploded view shows the protective case 300 including enclosure portions 310A and 310B, a pipe fitting 390 that is to be enclosed by the enclosure portions 310A and 310B joined together at a side thereof by a hinge 320, a sealing gasket 340, and wire ties 370 to securely and hermetically enclose the pipe fitting assembly 390 in the enclosure portions 310A and 310B with the sealing gasket 340 inserted therebetween, in accordance with various examples. In other examples, the sealing gasket 340 may be pre-installed in the enclosure portions 310A and 310B, e.g., during a manufacturing process. In various examples, the sealing gasket 340 may have substantially the shape of the enclosure portions 310A and 310B. Specifically, the sealing gasket 340 has a contour that conforms to the contour of the enclosure portions 310A and 320B, and has a hollow middle portion to provide space for the pipe fitting 390 to be inserted therein. As such, the sealing gasket has openings 345 at the same locations and having the same shape as the openings 385 of the enclosure portions 310A and 310B.

According to various examples of the disclosure, the pipe fitting 390 may be inserted within the enclosure portions 310A and 310B, where the sealing gasket 340 is between the enclosure portions 310A and 310B and the pipe fitting 390 so as to ensure a snug and/or hermetic fit when the enclosure portions 310A and 310B are joined together and closed. In certain examples, the sealing gasket 340 may be pre-installed in the enclosure portions 310A and 310B.

The pipe fitting 390 may be inserted within the enclosure portions 310A and 310B. The sealing gasket 340 is between the enclosure portions 310A and 310B and the pipe fitting 390 to ensure a snug and substantially hermetic fit when the enclosure portions 310A and 310B are closed together. In an example, the enclosure portions 310A and 310B are joined together and sealed via wire or zip ties 370 (see FIG. 3B). In other examples of the disclosure, the enclosure portions 310A and 310B are joined together and sealed via a clasp 375 (see FIG. 3A) which may be used instead of, or in addition to, the wirc/zip tics 370. In various examples, the enclosure portions 310A and 310B have openings 385, inside which the pipe fitting tubes are to be inserted, and the openings 385 may have a ribbed configuration. For example, the ribbed configuration may render plugging the opening in a snug and substantially hermetic manner easier.

In other examples, FIGS. 3D-3F illustrate various types of pipe fittings 390 that may be protected by the protective case 300, according to various aspects. In various examples, FIG. 3D illustrates a T-shaped pipe fitting 390-1, FIG. 3E illustrates an elbow-shaped fitting 390-2, and FIG. 3F illustrates a straight-shaped fitting 390-3. In each of the cases illustrated in FIGS. 3D-3F, the enclosure portion 310A is the same, as discussed above with respect to FIGS. 3A-3C. However, in the case of the straight fitting 390-3, where only two of the openings 380 form a fluid passageway and can contain a pipe fitting tube 360, in the third opening which does not receive a tube 360, a plug 395 is inserted. In various examples, the plug 395 may be removable and may have a threaded configuration so as to be screwed in, or threaded in, a threaded opening 385a illustrated in FIG. 3C. The plug 395 ensures that the pipe fitting 390-3 remains sealed and protected from the environment, e.g., when buried underground. For example, the combination of the sealing gasket 340, the enclosure portions 310A/310B and the plug 395 provide a snug and/or hermetic sealing of the pipe fitting 390 enclosed therein. Similarly, in the case of an elbow-shaped fitting 390-2, the plug 395 may be inserted in the opening that does not receive a pipe fitting tube, and also provides a snug and/or hermetic sealing of the pipe fitting 390-2 enclosed therein.

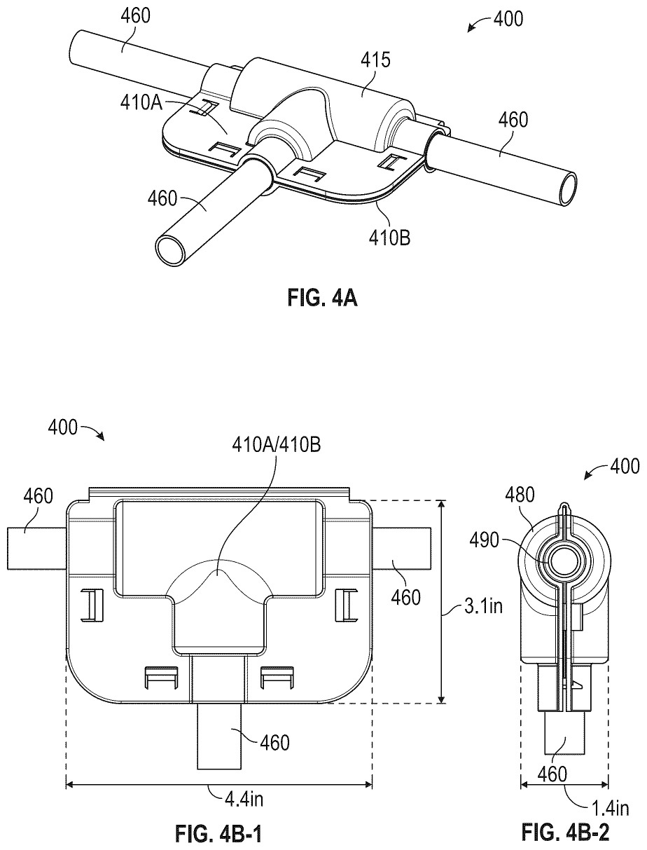

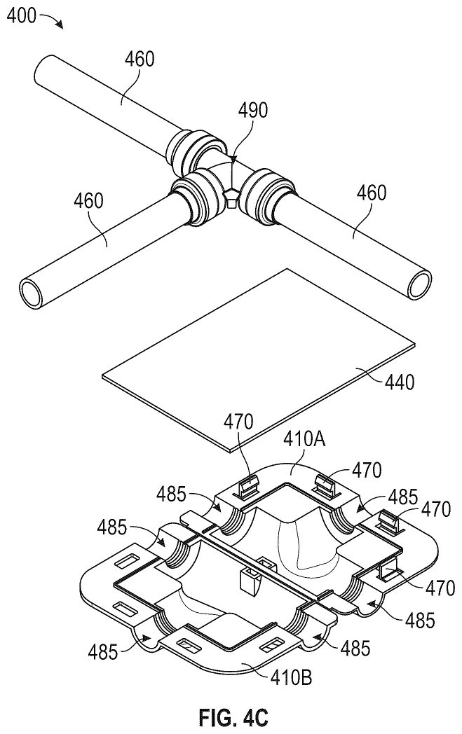

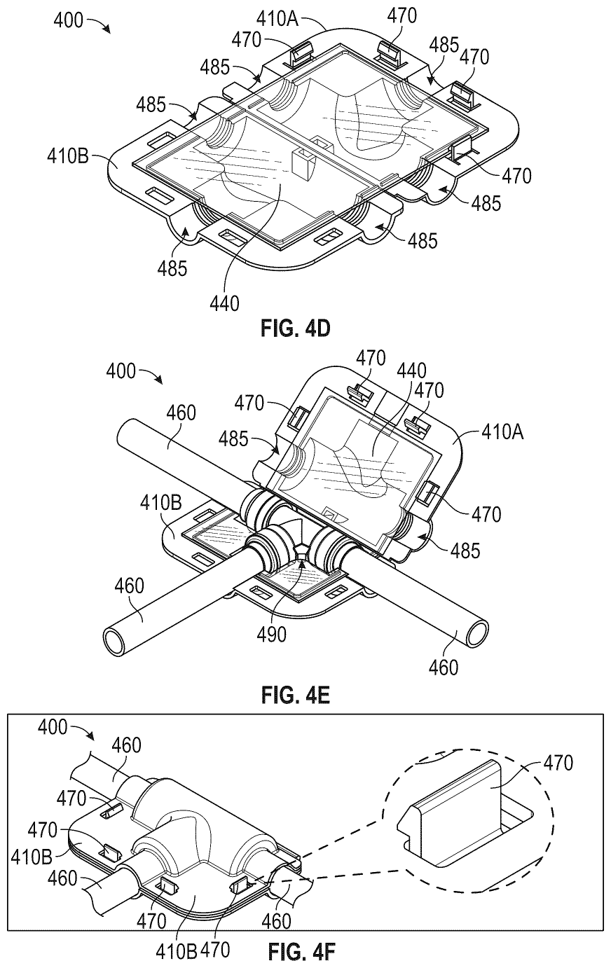

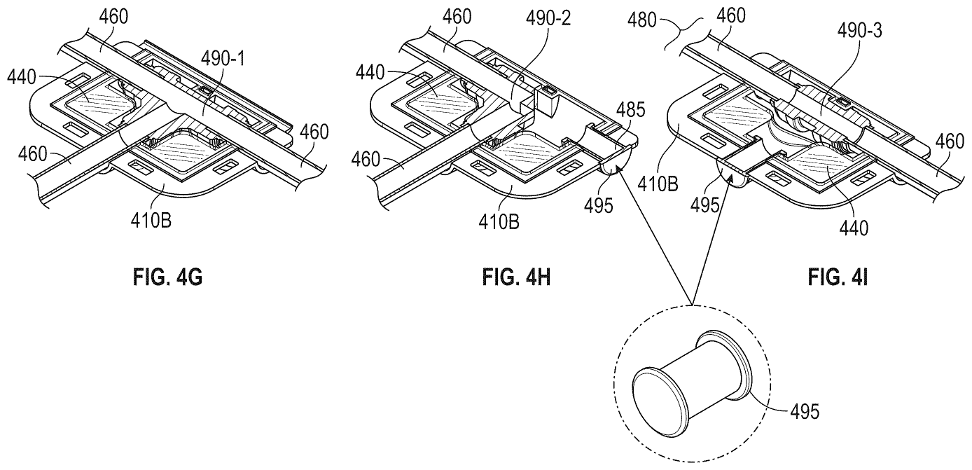

FIGS. 4A-4G are illustrations of a protective case for a pipe fitting, according to various examples of the disclosure. FIG. 4A is an illustration of a protective case 400 in operation, according to various examples of the disclosure. In FIG. 4A, both enclosure portions 410A and 410B are shown in a closed configuration. The enclosure portions 410A and 410B may have a flat outer surface in which fluid passageways 415 are embossed. The enclosure portions 410A/410B provide a protective case for a pipe fitting (not shown) and pipe tubes 460 connected to the pipe fitting.

In FIG. 4B, dimensions of the protective case 400, according to various examples of the disclosure, are illustrated. The protective case 400 illustrated in FIG. 4B is similar to the protective case 400 illustrated in FIG. 4A. The radius of opening 480 of the protective case 400 through which a pipe fitting tube 460 may be inserted is equal to about 1.4 in. In other examples, a width of the protective case 400 along one axis is equal to about 3.1 in, and a length of the protective case 400 along another axis is equal to about 4.4 in.

FIG. 4C is an exploded view of a protective case 400, in accordance with various examples of the disclosure. In FIG. 4C, the exploded view includes enclosure portions 410A. 410B, a pipe fitting 490 that is to be enclosed within the enclosure portions 410A, 410B, and a sealing sheet 440 such as, e.g., a silicone sheet 440, in accordance with various examples. In various examples, the sealing sheet 440 extends between the first enclosure portion 410A and the second enclosure portion 410B and provides the same function as the sealing gaskets discussed above with respect to FIGS. 2A-2F and 3A-3F.

FIG. 4D illustrates an operation of the protective case 400, according to various examples of the disclosure. In FIG. 4D, the sealing sheet 440 is shown inserted between the enclosure portions 410A and 410B. The enclosure portions 410A, 410B and the sheet 440 may receive the pipe fitting 490 therein. Upon closure of the enclosure portions 410A, 410B, the pipe fitting 490 is snugly and/or hermetically enclosed within the protective case 400. In certain examples, the sheet 440 may be pre-installed in the enclosure portions 410A and 410B prior to enclosing the pipe fitting 490, and when the pipe fitting 490 is inserted in the protective case 400 and the enclosure portions 410A, 410B are closed together, the sealing sheet 440 within the enclosure portions 410A and 410B may snugly wrap around the shape of the enclosed pipe fitting 490 to ensure better sealing of the pipe fitting 490.

FIG. 4F illustrates an operation of the protective case 400, according to various examples of the disclosure. In FIG. 4E, the pipe fitting 490 may be inserted within the enclosure portions 410A, 410B, and the pre-installed sealing sheet 440 is between the enclosure portions 410A, 410B and the pipe fitting 490. In an example, the enclosure portions 410A, 410B are joined together and sealed via a clasp 470.

As depicted in FIG. 4C, the enclosure portion 410B has openings 485, inside which the pipe fitting tubes are to be inserted, and the openings 485 may have a ribbed configuration. For example, the ribbed configuration in the opening 485 may render plugging the opening in a snug and substantially hermetic manner easier.

In other examples, FIGS. 4G-4I illustrate various types of pipe fittings 490 that may be protected by the protective case 400, according to various aspects. In various examples, FIG. 4G illustrates a T-shaped pipe fitting 490-1, FIG. 4H illustrates an elbow-shaped fitting 490-2, and FIG. 4I illustrates a straight-shaped fitting 490-3. In each of the cases illustrated in FIGS. 4G-4I, the enclosure portion 410B and the sealing sheet 440 in the enclosure portion 410B are the same as discussed above with respect to FIGS. 4A-4F. However, in the case of the straight fitting 490-3, where only two of the openings 480 form a fluid passageway and can contain a pipe fitting tube 460, in the third opening 485 which does not receive a tube 460, a plug 495 is inserted in the third opening 485 of the enclosure portion 410B. In various examples, the plug 495 may be threaded so as to be screwed in, or threaded in, the threaded opening 485 which may be ribbed. The plug 495 ensures that, when the pipe fitting 490 does not include a third pipe, the pipe fitting 490-3 remains sealed and protected from the environment. For example, the combination of the sealing sheet 440, the enclosure portions 410A/410B and the plug 495 provides a snug and/or hermetic sealing of the pipe fitting 490 enclosed therein. Similarly, in the case of an elbow-shaped fitting 490-2, the plug 495 may be inserted in the third opening 485, and also provides a snug and/or hermetic sealing of the pipe fitting 490-2 enclosed therein.

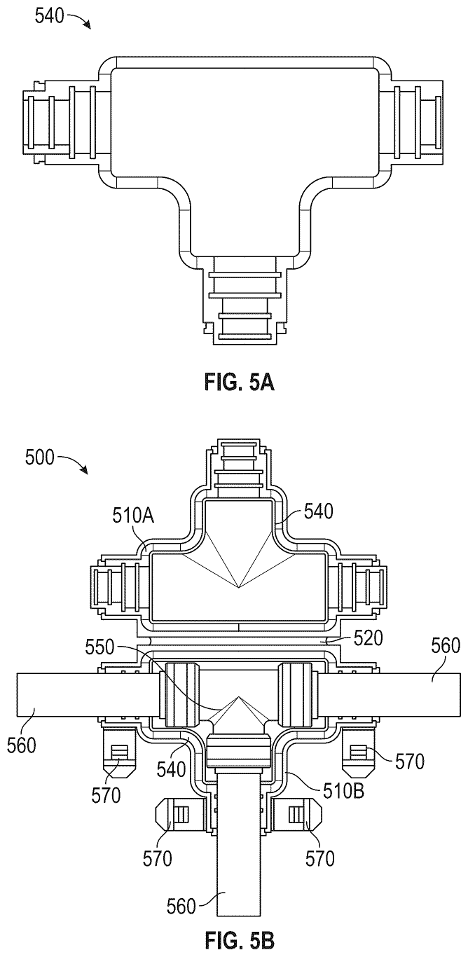

FIGS. 5A-5B are illustrations of a protective case for a pipe fitting, according to various examples of the disclosure. FIG. 5A illustrates a sealing gasket 540 similar to the sealing gasket 140 described above with respect to FIG. 1B. FIG. 5B illustrates a protective case in operation similar to the protective case described above with respect to FIG. 1D, according to various examples of the disclosure. In examples, the protective case 500 is in an open configuration, and one of the first enclosure portion 510A and the second enclosure portion 510B encloses one or more pipe fitting tubes 560 in a fluid configuration. In various examples, the pipe fitting tubes 560 are in a T-shaped configuration. In the example illustrated in FIG. 5B, the closing or joining mechanisms 570 are clasps 570, but may be or include other types of closing or fastening mechanisms such as, e.g., a wire tie, and a screw. In FIG. 5B, the pipe fitting tubes 560 are joined together by a joining mechanism 550. For example, the joining mechanism 550 may be a T-shaped pipe having a diameter large enough to snugly accommodate each of the pipe fitting tubes 560 therein. In operation, the pipe fitting tubes 560 are snugly fitted into the joining mechanism 550 to ensure an unencumbered fluid pathway. In examples, the closed protective case 500 includes the pipe fitting tubes 560 in a T-shaped configuration, although alternatives are possible.

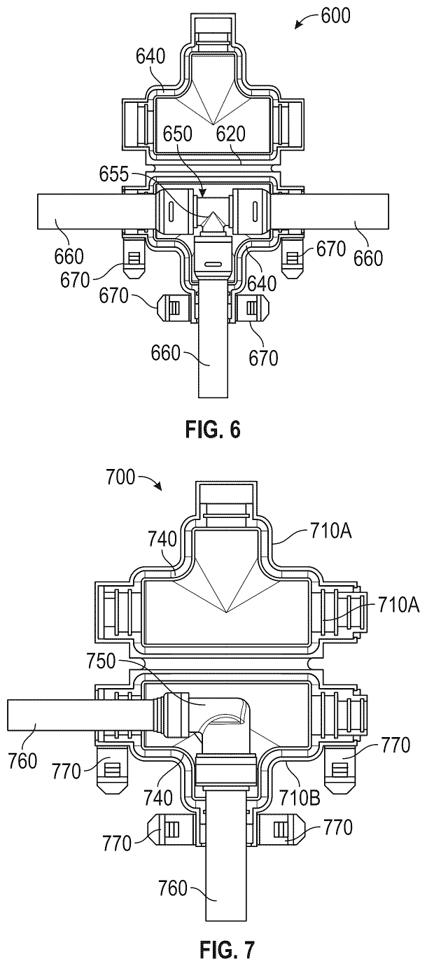

FIG. 6 is an illustration of a protective case 600 for a pipe fitting, according to various examples of the disclosure. In FIG. 6, the pipe fitting tubes 660 are in a T-shaped configuration, similarly to FIG. 5B, but in FIG. 6, the joining mechanism 650 includes three (3) portions, each portion being fluidly connected to a pipe fitting tube 660, and a fourth portion 655. In various examples, the fourth portion 655 is configured to fluidly connect the three portions 650 of the joining mechanism. For examples, although the portions 650 may have to have a diameter sufficiently large to snugly accommodate the pipe fitting tubes 660 therein, the fourth portion 655 may have a different diameter, either larger or smaller, than the pipe fitting tubes 660, as long as the fourth portion 655 can provide a sufficient fluid pathway to allow, e.g., a liquid to travel therethrough. In the example illustrated, the closing or joining mechanisms 670 are clasps 670, but may be or include other types of closing or fastening mechanisms such as, e.g., a wire tie, and a screw.

FIG. 7 is an illustration of a protective case 700 for a pipe fitting, according to various examples of the disclosure. In FIG. 7, the pipe fitting tubes 760 are in an elbow-shaped configuration, where two pipe fitting tubes 760 are connected together with an elbow-shaped joining mechanism 750. In examples, the protective case 700 is in an open configuration, and one of the first enclosure portion 710A and the second enclosure portion 710B encloses one or more pipe fitting tubes 760 in a fluid configuration. In various examples, the pipe fitting tubes 760 are in an elbow-shaped configuration. In the example illustrated, the closing or joining mechanisms 770 are clasps 770, but may be or include other types of closing or fastening mechanisms such as, e.g., a wire tie, and a screw. In certain examples, the pipe fitting tubes 660 can be joined together by a joining mechanism 750. For example, the joining mechanism 750 may be an elbow-shaped pipe having a diameter large enough to snugly accommodate each of the pipe fitting tubes 760 therein. In operation, the pipe fitting tubes 760 are snugly fitted into the joining mechanism 750 to ensure an unencumbered fluid pathway. In various examples, as there are only two pipe fitting tubes 760 that are joined in the protective case 700 in this elbow configuration, an opening 740 of the protective case 700 may be plugged, e.g., substantially hermetically plugged via, e.g., a plug similar to the plug portion 155 illustrated above with respect to FIG. 1F. In examples, the closed protective case 700 includes the pipe fitting tubes 760 in an elbow-shaped configuration, although alternatives are possible.

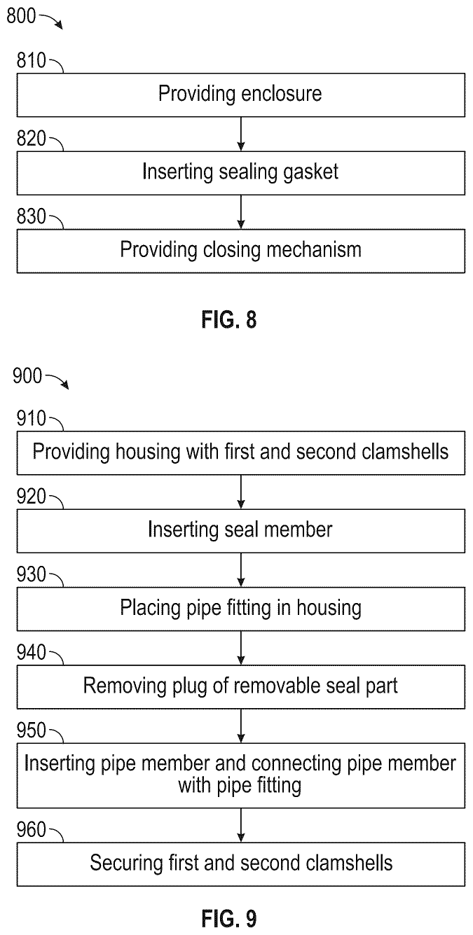

FIG. 8 is a flow chart 800 illustrating a method of making a protector case for a pipe fitting for direct burial application, according to various examples of the disclosure. In various examples, operation 810 includes providing an enclosure having two shell portions, e.g., a first shell portion and a second shell portion, for housing the pipe fitting. For example, each of the first and second shell portions include a plurality of side features at sides thereof and having a concave configuration. In other examples, operation 820 includes inserting a sealing gasket inside at least one of the first and second shell portions. In various examples, inserting the sealing gasket during operation 820 includes inserting a silicone sheet between the first shell portion and the second shell portion. In other examples, operation 830 includes providing a closing or joining mechanism for the first and second shell portions. In a closed configuration, the first shell portion and the second shell portion may join together to form a plurality of openings in at least a three prong configuration for receiving at least two pipes that are oriented to conform to a configuration of the pipe fitting.

FIG. 9 is a flow chart 900 illustrating a method of protecting a pipe fitting, according to various examples of the disclosure. In various examples, operation 910 includes providing a housing that includes a first clamshell and a second clamshell. For example, the first and second clamshells are configured to couple together in a closed configuration to define an interior and a plurality of pipe openings. The pipe openings may form, e.g., at least a 3-prong configuration. In other examples, operation 920 includes inserting a seal member into the housing to form a seal. For example, when the first and second clamshells are in the closed configuration, the seal member has a removable seal part that forms a plug at each pipe opening. For example, the seal member has a length that extends around the pipe member between about ¼ inch to about 1 inch. In examples, operation 930 includes placing the pipe fitting into the interior of the housing. Operation 940 includes removing the plug of the removable seal part to provide access into the interior of the housing through a respective pipe opening. In another example, operation 950 includes inserting, where the plugs have been removed, a pipe member, and connecting the pipe member with the pipe fitting within the housing. In other examples, operation 960 includes securing the first and second clamshells in the closed configuration such that the removable seal part of the seal member forms a seal about the pipe member at the plurality of pipe openings.

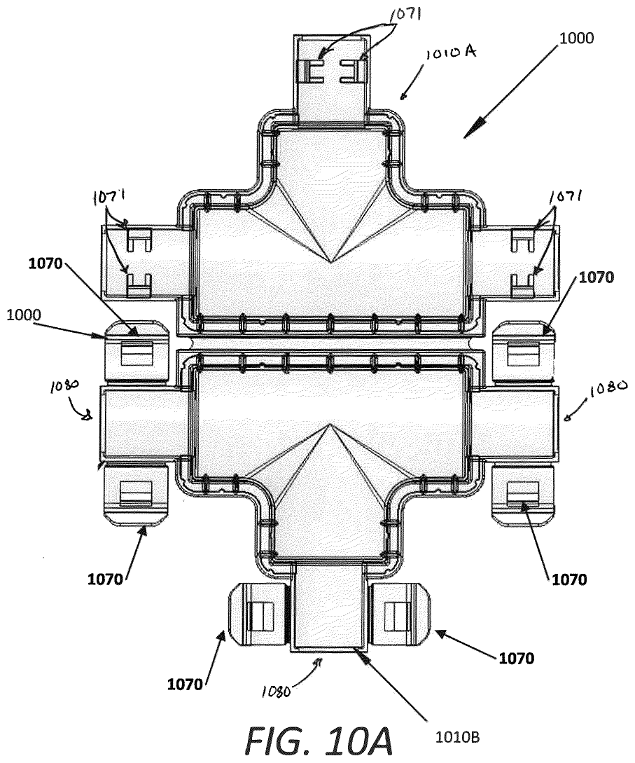

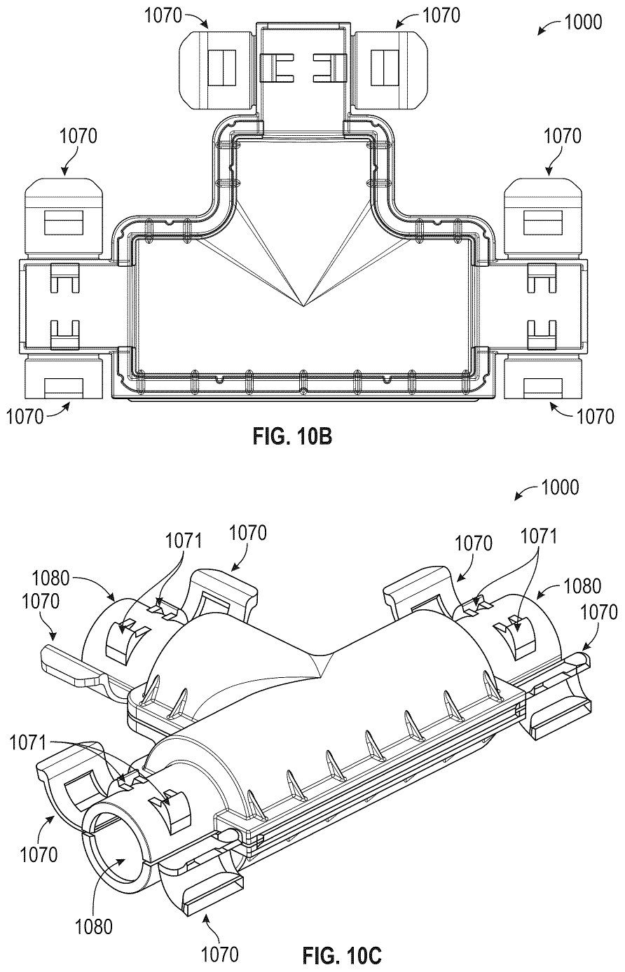

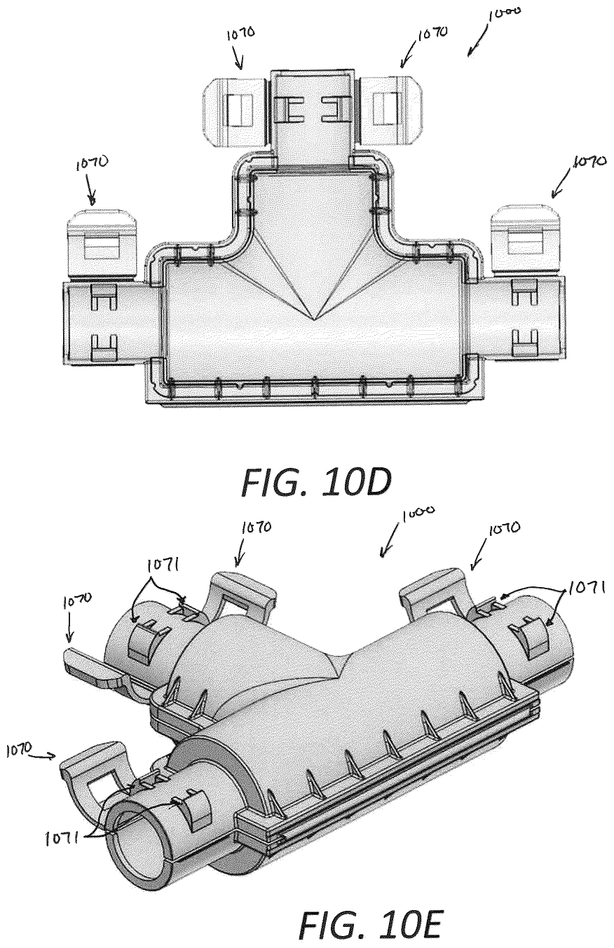

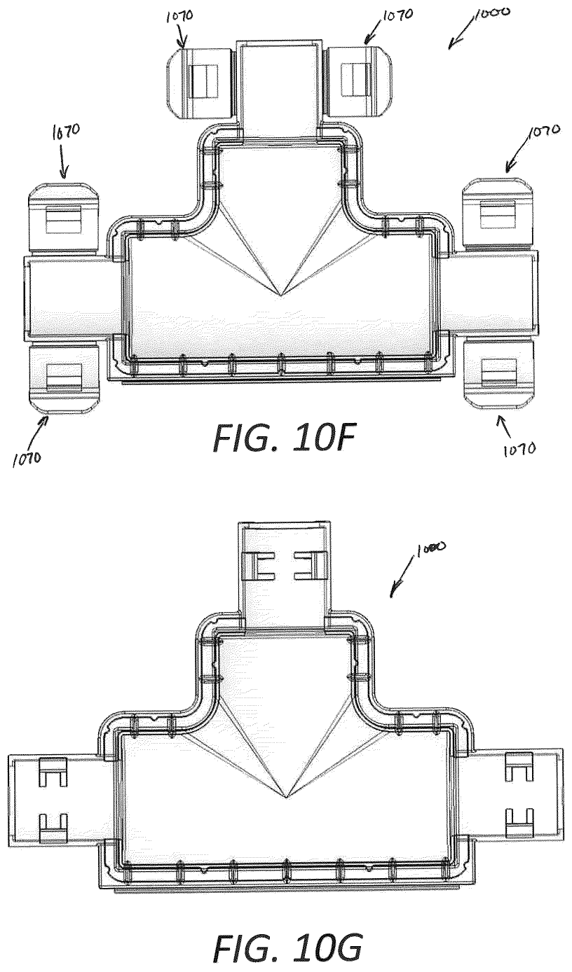

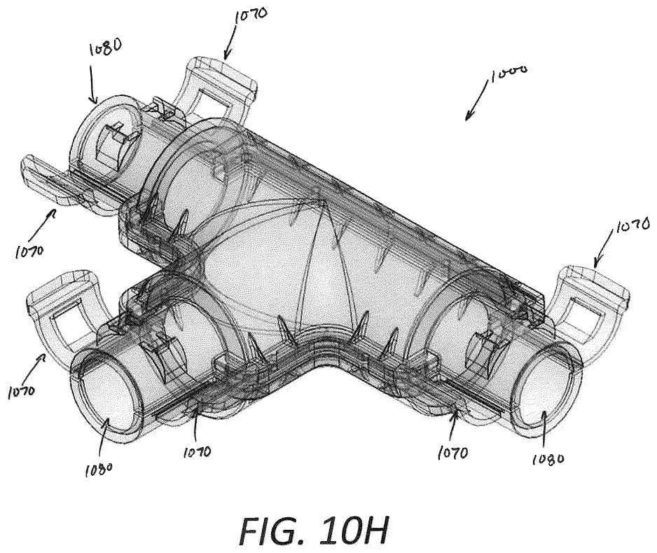

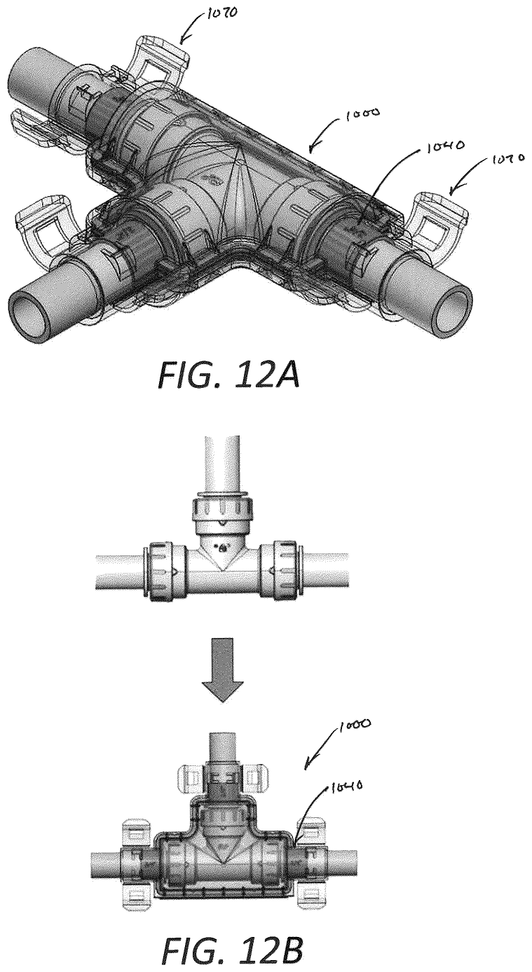

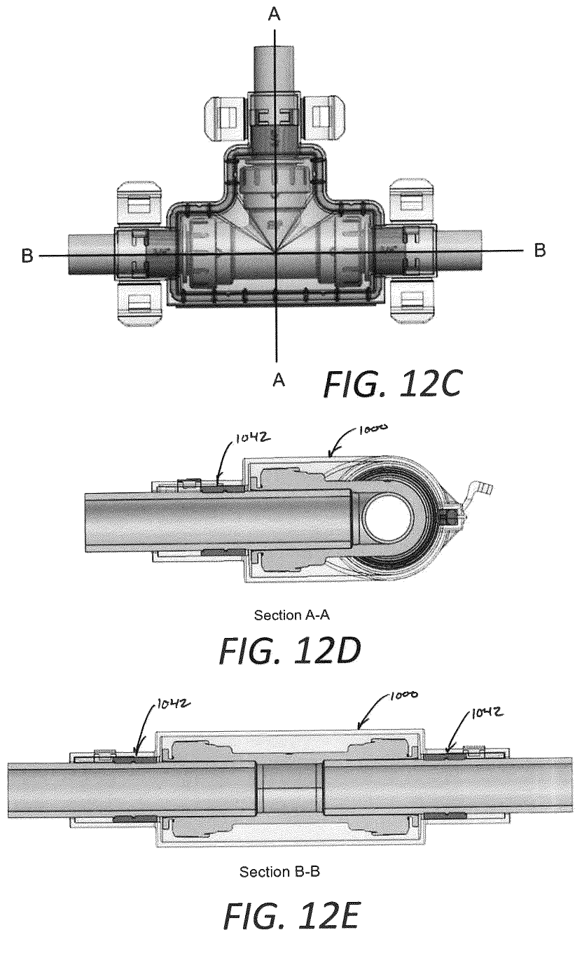

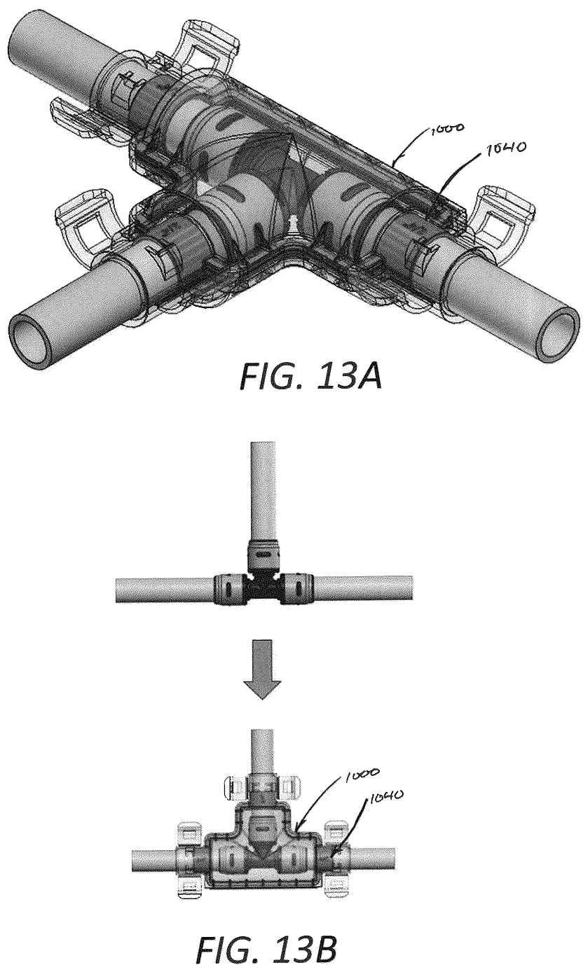

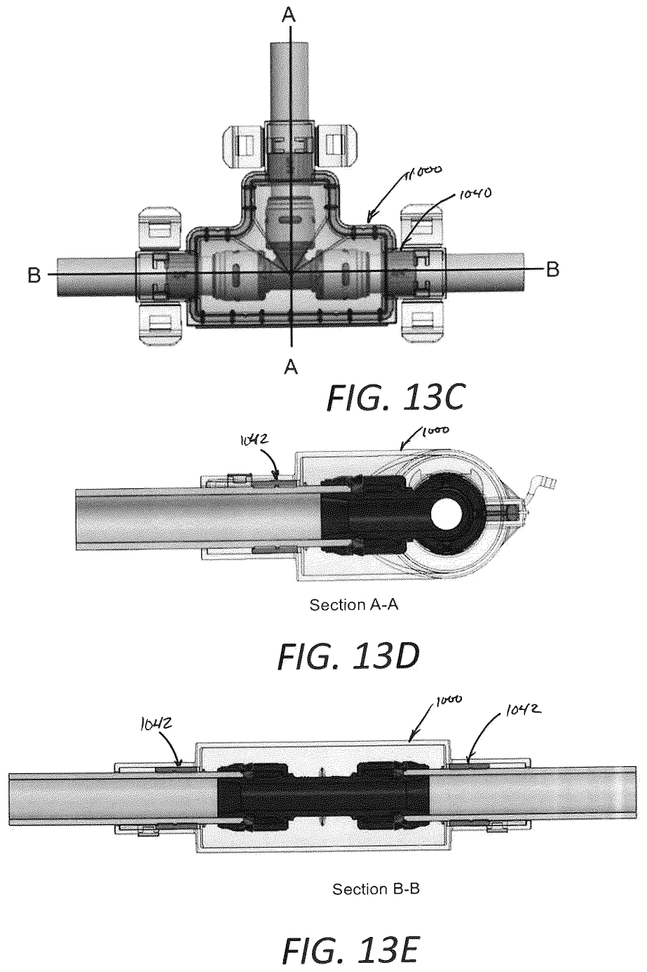

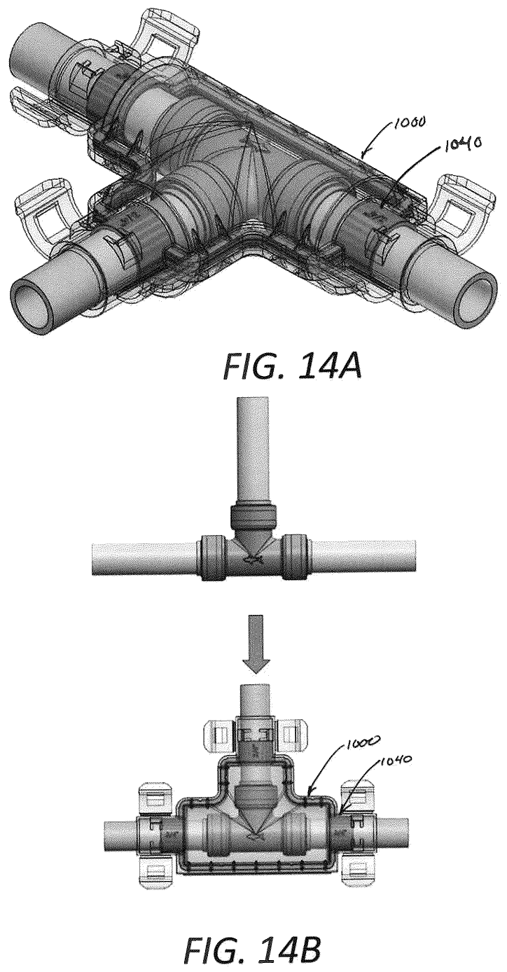

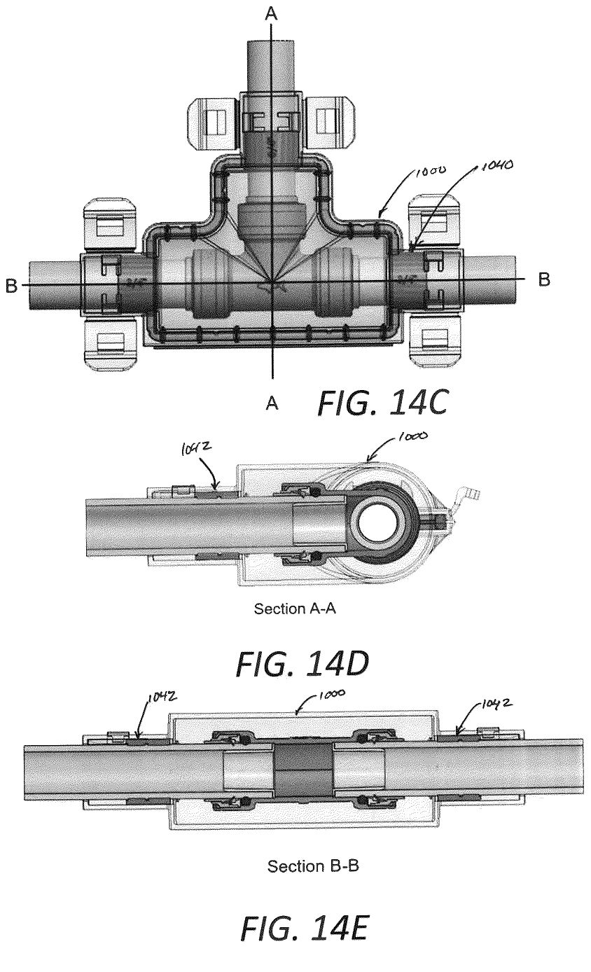

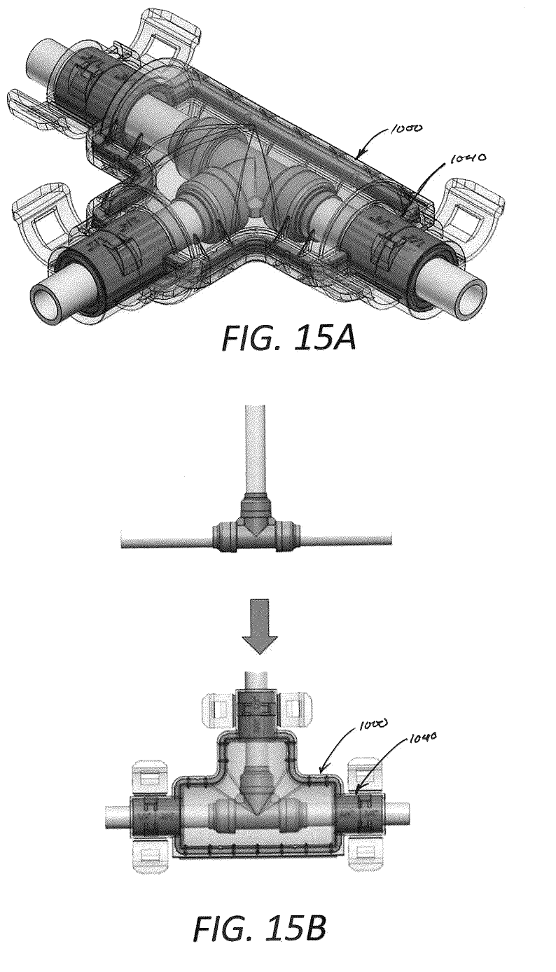

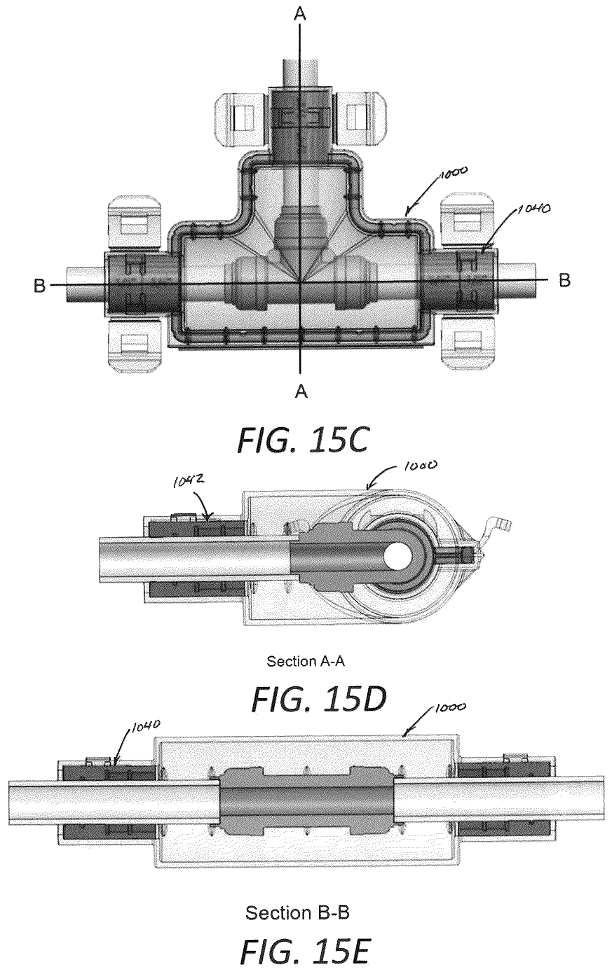

FIGS. 10A-10H, 12A-12E, 13A-E, 14A-E, and 15A-E show additional embodiments of a protective case 1000. The protective case 1000 includes enclosure portions 1010A and 1010B having a plurality of clasps 1070 attached thereto. The clasps 1070 are movable or deformable to lock cach of the enclosures 1010A and 1010B in place together and around a pipe fitting and to seal the gasket/seal 1040 against the outer surfaces of the pipes or tubing or conduits connected to the pipe fitting. As indicated in FIGS. 10A-10H, 12A-12E, 13A-E, 14A-E, and 15A-E, the case 1000 includes pluralities of clasps 1070 positioned on the case 1000 along or adjacent pipe/tubing openings 1080 defined by the case 1000 and corresponding pluralities of tabs 1071 positioned along the case 1000 for engagement by respective ones of the pluralities of clasp 1070. In the illustrated embodiments, the pluralities of clasps 1070 includes pairs of clasps 1070 positioned on opposing sides of an enclosure 1010A (or 1010B) and corresponding pairs of tabs or projections positioned on opposing sides the opposite enclosure 1010B (or 1010A). In alternative or additional embodiments, the enclosures 1010A/B can each have one clasp and one tab adjacent the openings that correspond to a clasp and tab on the opposite enclosure.

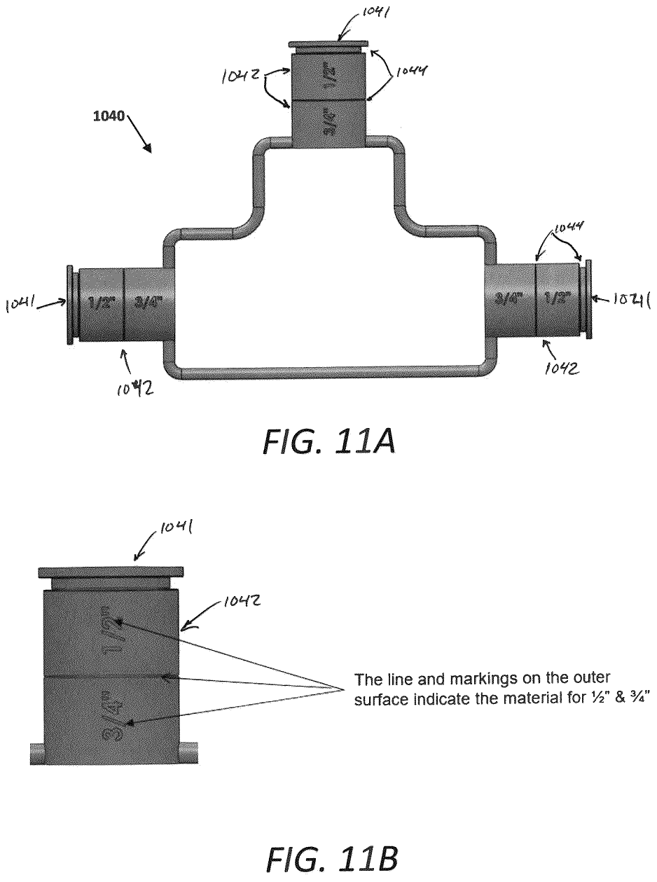

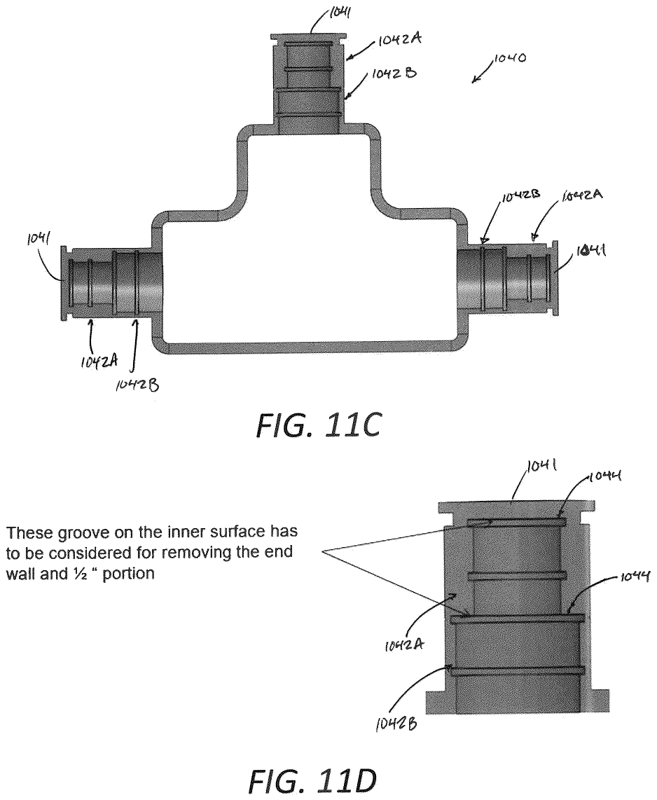

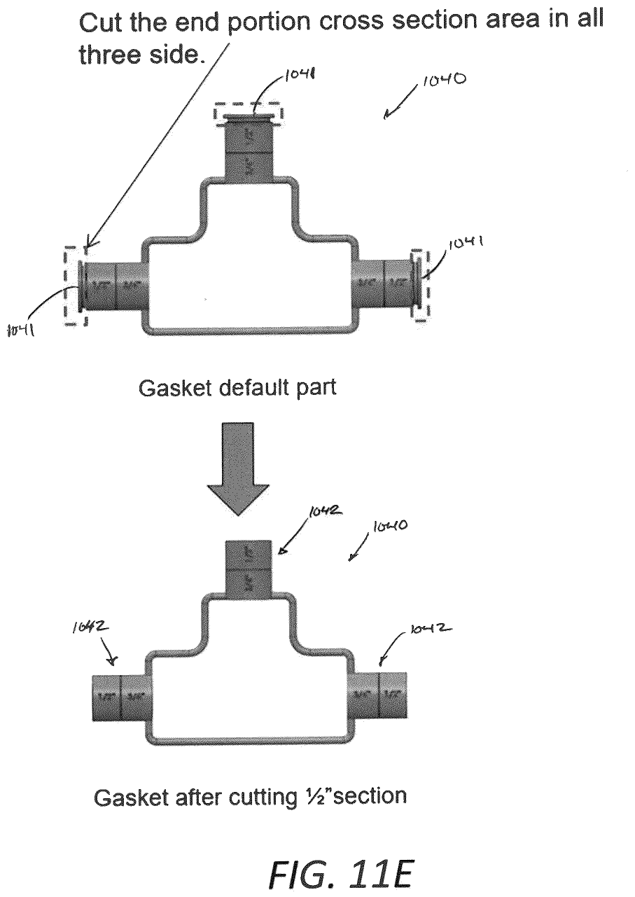

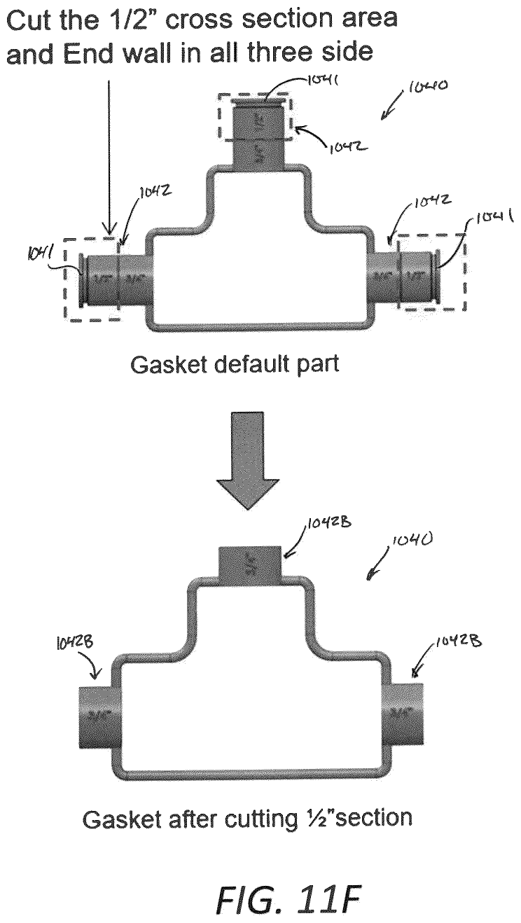

FIGS. 11A-11F show another embodiment of a gasket 1040. The gasket 1040 includes caps 1041 and a stepped portion or section 1042 including a plurality of variable sized cross-sectional areas 1042A, 1042B corresponding to various tubes, pipe, or conduit outer diameters (such as ½″ or ¾″ or other pipe sizes). In this regard, one or more of the areas of the gasket 1040 can be removed to allow for sealing on various pipe sizes. For example, as shown in FIGS. 11A-F, an initial area (e.g., the ½″ area) can have an inner diameter that is smaller than an adjacent section or area (e.g., the ¾″ area) and the initial area can be kept in place to seal on a pipe or conduit of a prescribed diameter (e.g., ½″) or can be removed to allow for sealing on a pipe or conduit with a larger diameter (e.g., ¾″). In the illustrated embodiment, two different sized areas are shown for sealing on pipes/conduits of two different diameters (e.g., ½″ and ¾″); however, the gasket can have more than two areas, such as three, four or more, to allow for sealing on more than two different sized pipes or conduits. The areas further can have one or more grooves or portions of weakening 1044 that allow for or otherwise help to facilitate removal of all or part of the sections to facilitate sealing on pipe/conduits of different diameters/sizes. As discussed previously, the caps can be removed from the gasket to allow variable sealing of the case 1000 for accommodating different coupling or fitting combinations, such as tees, elbows, end caps, ore straight fittings. The gasket also have grooves or portions of weakening corresponding to the caps to help facilitate removal thereof.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Various modifications and alterations of this disclosure will become apparent to those skilled in the art without departing from the scope and spirit of this disclosure, and it should be understood that the inventive scope of this disclosure is not to be unduly limited to the illustrative examples set forth herein.

1. A protective case for a pipe fitting, the protective case comprising:
an enclosure including a shaped cavity, the enclosure comprising a first enclosure portion and a second enclosure portion, the first enclosure portion and the second enclosure portion being coupled together via a hinge;
a sealing gasket shaped to conform to at least a portion of the enclosure; and
a joining mechanism configured to secure the first and second enclosure portions together in a closed configuration with at least a portion of the sealing gasket positioned therebetween;
wherein, when in the closed configuration, the enclosure defines a plurality of openings arranged in at least a three prong configuration to receive at least two pipes that are oriented to conform to a configuration of the pipe fitting.

2. The protective case of claim 1, wherein the sealing gasket includes a first sealing gasket that mounts within a cavity of the first enclosure portion and a second sealing gasket that mounts within a cavity of the second enclosure portion, wherein, when the enclosure is in the closed configuration, the first and second sealing gaskets together define a plurality of gasket openings.

3. The protective case of claim 2, wherein the first and second sealing gaskets each include a pipe portion, and wherein, when the first and second enclosure portions are in the closed configuration, the first and second sealing gaskets together form a plug at one or more of the plurality of gasket openings.

4. The protective case of claim 2, wherein each one of the plurality of gasket openings coincides with a respective one of the plurality of openings.

5. The protective case of claim 1, further comprising a removable plug configured to seal one of the plurality of openings.

6. The protective case of claim 5, wherein the removable plug has a threaded configuration.

7. The protective case of claim 1, wherein the sealing gasket extends along a portion of at least a perimeter of one of the first enclosure portion and the second enclosure portion.

8. The protective case of claim 1, wherein the sealing gasket comprises a sheet extending between the first enclosure portion and the second enclosure portion.

9. The protective case of claim 8, wherein the sheet comprises a silicone sheet.

10. The protective case of claim 1, wherein the joining mechanism comprises at least one of a clasp, a wire tie, and a screw.

11. The protective case of claim 1, wherein a length of the protective case along a first axis is cqual to or smaller than 4.8 in.

12. The protective case of claim 1, wherein a width of the protective case along a second axis is equal to or smaller than 3.6 in.

13. The protective case of claim 1, wherein a radius of one of the plurality of openings of the protective case is equal to or smaller than 1.8 in.

14. The protective case of claim 1, wherein the shape of the pipe fitting comprises at least one of a straight line shape, an elbow shape, a T-shape, a Y-shape, and a star shape.

15. The protective case of claim 1, wherein the hinge is a living hinge.

16. The protective case of claim 1, wherein the sealing gasket has a step down configuration that includes at least a first section and a second section for receiving various sizes of pipe fittings.

17. A method of making a protector case for a pipe fitting for direct burial application, the method comprising:
providing an enclosure having a first shell portion and a second shell portion for housing the pipe fitting;
inserting a sealing gasket within the enclosure ; and
providing a closing mechanism for securing the first enclosure portion to the second enclosure portion;
wherein, in a closed configuration:
the first shell portion and the second shell portion join together to form a plurality of openings in at least a three prong configuration for receiving at least two pipes that are oriented to conform to a configuration of the pipe fitting.

18. The method of claim 17, wherein inserting the scaling gasket within the enclosure comprises inserting a silicone sheet between the first shell portion and the second shell portion.

19. A method of protecting a pipe fitting, the method comprising:
providing a housing including a first clamshell and a second clamshell, the first and second clamshells being configured to couple together in a closed configuration to define an interior and a plurality of pipe openings that form at least a 3-prong configuration;
inserting a seal member into the housing to form a seal when the first and second clamshells are in the closed configuration, the seal member having a removable seal part that forms a plug at each one of the plurality of pipe openings;
placing the pipe fitting into the interior of the housing;
removing the plug of the removable seal part to provide access into the interior of the housing through a respective one of the plurality of pipe openings;
inserting, where the plugs have been removed, a pipe member, and connecting the pipe member with the pipe fitting within the housing; and
securing the first and second clamshells in the closed configuration such that the removable seal part of the seal member forms a seal about the pipe member at the plurality of pipe openings.

20. The method of claim 19, wherein the seal member has a length that extends around the pipe member between about ¼ inch to about 1 inch.
